(19) United States
(12) Patent Application Publication
(10) Pub. No.: US 2020/0289953 A1
(43) Pub. Date: Sep. 17, 2020

(54) Simulation Intelligent Electric Toy Car with Intelligent Path Planning

(71) Applicant: Chi Wai NG, Hong Kong (HK)

(72) Inventor: Chi Wai NG, Hong Kong (HK)

(21) Appl. No.: 16/416,274

(22) Filed: May 20, 2019

(30) Foreign Application Priority Data
Mar. 13, 2019 (CN) 201910186767.0

(51) Int. Cl. A63H 17/395; A63H 29/22; A63H 29/24; A63H 17/26; G05D 1/02; G05D 1/00; B60L 53/36; H02S 99/00

(52) U.S. Cl. CPC A63H 17/395; A63H 29/22; A63H 29/24; A63H 17/262; G05D 1/0221; G06F 3/16; G05D 1/0022; B60L 53/36; H02S 99/00; A63H 2200/00; B60L 2200/20; G05D 1/0088

(57) ABSTRACT

The invention relates to a simulation intelligent electric toy car with intelligent path planning which includes: a positioning module, configured to mark elevator position coordinates and home door position coordinates in the same coordinate system, and drive the toy car to automatically travel from the home door to the elevator and travel from the elevator to the home door according to the elevator position coordinates and the home door position coordinates; a marking module, configured to mark coordinates of a specific location according to an indication of the user; a planning module, configured to plan a specific path according to coordinates of the specific location, and drive the toy car to automatically travel along the specific path; an acquiring module, configured to acquire, by using a camera, an object that which the toy car passes through car during driving; a processing module, configured to analyze the object to obtain a name and related content of the object, and convert the related content into an audio format for playing and provide various functions.

### FIELD OF THE INVENTION

The invention relates to the field of toy technology, in particular to a simulation intelligent electric toy car with intelligent path planning.

### BACKGROUND

In the prior art, there is a highly simulated electric vehicle toy that allows a child to drive a toy car as a driver. However, the existing toy car has the following problems: before use, the parents need to carry a bulky toy cars into the elevator, which is not easy to operate. When the toy car is not in use, it is used in the home to waste the floor space and has no other use. There are potential safety risks for children as drivers.

The information disclosed in this Background section is only intended to provide an understanding of the general background of the invention, and should not be construed as an admission.

### SUMMARY OF THE INVENTION

The object of the present invention is to provide a simulation intelligent electric toy car with intelligent path planning.

To solve the above problem, the present invention provides a simulation intelligent electric toy car with intelligent path planning which includes:

a positioning module, configured to mark elevator position coordinates and home door position coordinates in the same coordinate system, and drive the toy car to automatically travel from the home door to the elevator and travel from the elevator to the home door according to the elevator position coordinates and the home door position coordinates;

a marking module, configured to mark coordinates of a specific location according to an indication of the user;

a planning module, configured to plan a specific path according to coordinates of the specific location, and drive the toy car to automatically travel along the specific path;

an acquiring module, configured to acquire, by using a camera, an object that which the toy car passes through car during driving;

a processing module, configured to analyze the object to obtain a name and related content of the object, and convert the related content into an audio format for playing;

a communication module, configured to communicate with a smart terminal of the user;

wherein the communication module is configured to implement a video call with a driver of the toy car through a camera disposed in the toy car and a camera of the smart terminal;

wherein the communication module is configured to send location information of the smart terminal to the toy car;

a setting module, configured to preset a relative position, wherein the toy car moves together with the smart terminal, and maintains the relative position with the smart terminal;

a displacement mechanism, configured to drive the toy car to be vertically or horizontally displaced by a predetermined amplitude;

a cleaning mechanism, wherein a chassis of the toy car is provided with an engaging opening, configured to engage with a rag, and further wherein the displacement mechanism is configured to drive the cleaning mechanism to be displaced such that the cleaning mechanism fits the ground, and further wherein when the toy car encounters an obstacle during driving, it automatically turns to 90 degrees;

a charging module, configured to detect power of the toy car, and drive the toy car to a preset charging port for charging according the position coordinate of the preset charging port when the power of the toy car is lower than a preset value;

a calculation module, configured to plan a travel route according to a destination set by the user, calculate a required power according to the travel route, detect a remaining power of the toy car, and send a reminder message to the smart terminal if the required power is greater than or equal to the remaining power of the toy car;

an internet connection module, configured to establish a connection with other smart home device, and send an operation instruction to the other smart home device when the toy car is within a predetermined distance from the home door position, so that the other smart home device executes the operation instruction.

In an example embodiment, the simulation intelligent electric toy car with intelligent path planning includes: a solar module. A housing of the toy car is made of a material capable of collecting solar energy. The collected solar energy is converted into electrical energy to supply electrical power to the toy car.

In an example embodiment, the simulation intelligent electric toy car with intelligent path planning includes that the communication module communicates with the smart terminal of the user through WIFI.

For the simulation intelligent electric toy car with intelligent path planning of present invention, the positioning module is configured to mark elevator position coordinates and home door position coordinates in the same coordinate system, and drive the toy car to automatically travel from the home door to the elevator and travel from the elevator to the home door according to the elevator position coordinates and the home door position coordinates. The toy car can automatically be driven inside the elevator for easy use.

For the simulation intelligent electric toy car with intelligent path planning of present invention, the marking module is configured to mark coordinates of a specific location according to an indication of the user. The planning module is configured to plan a specific path according to coordinates of the specific location, and drive the toy car to automatically travel along the specific path. It can make the toy car automatically travel along the preset road routing, which is easy to operate and easy for parents to take care of children.

For the simulation intelligent electric toy car with intelligent path planning of present invention, the acquiring module is configured to acquire, by using a camera, an object that which the toy car passes through car during driving. The processing module is configured to analyze the object to obtain a name and related content of the object, and convert the related content into an audio format for playing. It can make the toy car be able to play the name and related content of the object in the street to children, which can enable children intuitively and specifically acquire knowledge and entertain.

For the simulation intelligent electric toy car with intelligent path planning of present invention, the communication module is configured to communicate with a smart terminal of the user. The communication module is configured to implement a video call with a driver of the toy car through a camera disposed in the toy car and a camera of the smart terminal, which allows parents to follow the toy car without going close, or to talk to children.

For the simulation intelligent electric toy car with intelligent path planning of present invention, the communication module is configured to send location information of the smart terminal to the toy car. The setting module is configured to preset a relative position, wherein the toy car moves together with the smart terminal, and maintains the relative position with the smart terminal, which enables the toy cars to follow the parent's movement and maintain a preset relative position with the parents.

For the simulation intelligent electric toy car with intelligent path planning of present invention, the displacement mechanism is configured to drive the toy car to be vertically or horizontally displaced by a predetermined amplitude, which makes the toy cars play the role of “rocking car” or cradle for comforting children.

The simulation intelligent electric toy car with intelligent path planning of present invention includes the cleaning mechanism. A chassis of the toy car is provided with an engaging opening, configured to engage with a rag. The displacement mechanism is configured to drive the cleaning mechanism to be displaced such that the cleaning mechanism fits the ground. When the toy car encounters an obstacle during driving, it automatically turns to 90 degrees.

For the simulation intelligent electric toy car with intelligent path planning of present invention, the charging module is configured to detect power of the toy car, and drive the toy car to a preset charging port for charging according the position coordinate of the preset charging port when the power of the toy car is lower than a preset value, which enables the toy cars to automatically charge.

For the simulation intelligent electric toy car with intelligent path planning of present invention, the calculation module is configured to plan a travel route according to a destination set by the user, calculate a required power according to the travel route, detect a remaining power of the toy car, and send a reminder message to the smart terminal if the required power is greater than or equal to the remaining power of the toy car.

For the simulation intelligent electric toy car with intelligent path planning of present invention, the internet connection module is configured to establish a connection with other smart home device, and send an operation instruction to the other smart home device when the toy car is within a predetermined distance from the home door position, so that the other smart home device executes the operation instruction.

Further features and aspects of the present invention will be illustrated from the Detailed Description of the Drawing.

### BRIEF DESCRIPTION OF THE DRAWINGS

The invention is illustrated by the following figures and embodiments.

FIG. 1 shows a schematic diagram of a simulation intelligent electric toy car with intelligent path planning in accordance with an example embodiment.

FIG. 2 shows a schematic diagram of a simulation intelligent electric toy car with intelligent path planning in accordance with an example embodiment.

The reference numbers of the figures are as follows:
10: toy car; 11: positioning module; 12: marking module; 13: planning module; 14: acquiring module; 15: processing module; 16: communication module; 17: setting module; 18: displacement mechanism; 19: cleaning mechanism; 110: charging module; 111: calculation module; 112: a solar module.

### DETAILED DESCRIPTION

The invention is illustrated in accordance with figures. The figures as simplified diagrams demonstrate the basic structures of the apparatus of embodiments of the invention. Thus, the invention is not limited to the figures.

The technical solutions in the embodiments of the present invention will be clearly and completely described in conjunction with the drawings in the embodiments of the present invention. It is a partial embodiment of the invention, and not all of the embodiments. All other embodiments obtained by those skilled in the art based on the embodiments of the present invention without creative efforts are within the scope of the present invention. The term “comprising” or variations such as “comprises” or “comprise”, etc., are to be understood to include the recited elements or components, and Other components or other components are not excluded.

The word “exemplary” is used exclusively herein to mean “serving as an example, embodiment, or illustrative.” Any embodiment described herein as “exemplary” is not necessarily to be construed as preferred or preferred.

In addition, numerous specific details are set forth in the Detailed Description of the invention in the Detailed Description. Those skilled in the art will appreciate that the invention may be practiced without some specific details. In some instances, methods, means, and components that are well known to those skilled in the art are not described in detail in order to facilitate the invention.

### Example 1

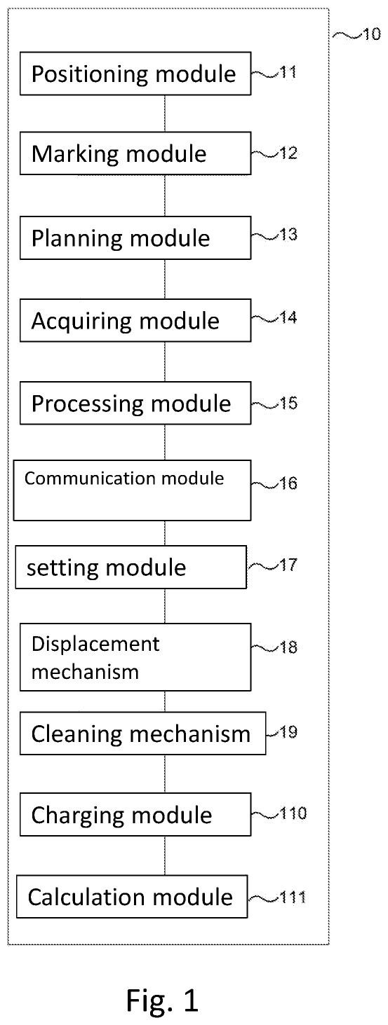

FIG. 1 shows a simulation intelligent electric toy car with intelligent path planning. As shown in FIG. 1, the simulation intelligent electric toy car 10 includes a positioning module 11, a marking module 12, a planning module 13, an acquiring module 14, a processing module 15, a communication module 16, a setting module 17, a displacement mechanism 18, a cleaning mechanism 19, a charging module 110 and a calculation module 111.

The positioning module 11 is configured to mark elevator position coordinates and home door position coordinates in the same coordinate system, and drive the toy car 10 to automatically travel from the home door to the elevator and travel from the elevator to the home door according to the elevator position coordinates and the home door position coordinates. The toy car can automatically be driven inside the elevator for easy use. Parents do not need to carry the toy car into the elevator by manpower.

The marking module 12 is configured to mark coordinates of a specific location according to an indication of the user. The planning module is configured to plan a specific path according to coordinates of the specific location, and drive the toy car to automatically travel along the specific path. It can make the toy car automatically travel along the preset road routing, which is easy to operate and easy for parents to take care of children.

Parents can plan specific routes along specific locations such as pavilions in the park, so that the toy car can automatically travel along the specific path, greatly reducing the human resources required for parents to supervise the toy car, providing parents with extreme great convenience.

The acquiring module 14 is configured to acquire, by using a camera, an object that which the toy car passes through car during driving. The processing module 15 is configured to analyze the object to obtain a name and related content of the object, and convert the related content into an audio format for playing. It can make the toy car be able to play the name and related content of the object in the street to children, which can enable children intuitively and specifically acquire knowledge and entertain.

When the child uses the toy car, the toy car can automatically broadcast information related to the scenery along the way. For example, when the toy car passes through the flower bed, the toy car can automatically recognize the name of the flower in the flower bed and play it out so that the child can get an intuitive understanding.

The communication module 16 is configured to communicate with a smart terminal of the user. The communication module is configured to implement a video call with a driver of the toy car through a camera disposed in the toy car and a camera of the smart terminal, which allows parents to follow the toy car without going close, or to talk to children.

The communication module 16 is configured to send location information of the smart terminal to the toy car. The setting module 17 is configured to preset a relative position, wherein the toy car moves together with the smart terminal, and maintains the relative position with the smart terminal, which enables the toy cars to follow the parent's movement and maintain a preset relative position with the parents.

In order to facilitate the parents to take care of the children, the position of the toy car should be located in front of the parents. For example, the relative position of the toy car can be preset to be 2 meters ahead of the smart terminal, so that the toy car can automatically follow the parent movement without manual operation, and keep 2 meters in front of the parents so parents can take care of the children.

The displacement mechanism 18 is configured to drive the toy car to be vertically or horizontally displaced by a predetermined amplitude, which makes the toy cars play the role of “rocking car” or cradle for comforting children.

The displacement mechanism 18 drives the vertical or horizontal displacement of the toy car so that the toy car can provide a variety of entertainment modes like the action of a “rocking car” or the action of a cradle.

As for the cleaning mechanism, a chassis of the toy car is provided with an engaging opening, configured to engage with a rag. The displacement mechanism 19 is configured to drive the cleaning mechanism to be displaced such that the cleaning mechanism fits the ground. When the toy car encounters an obstacle during driving, it automatically turns to 90 degrees so that the toy car can be used to clean the ground.

The charging module 110 is configured to detect power of the toy car, and drive the toy car to a preset charging port for charging according the position coordinate of the preset charging port when the power of the toy car is lower than a preset value, which enables the toy cars to automatically charge.

The calculation module 111 is configured to plan a travel route according to a destination set by the user, calculate a required power according to the travel route, detect a remaining power of the toy car, and send a reminder message to the smart terminal if the required power is greater than or equal to the remaining power of the toy car.

When the user sets the destination to “Blue Sky Kindergarten”, the calculation module 111 can query the kindergarten address through the network, and plan a driving route according to the address. If various driving routes are available for the user to select, the required power electricity is calculated according to the driving route. The required power electricity should be reasonably reserved for a certain margin. The round-trip power electricity is calculated. The remaining power electricity of the toy car is detected. When the required power electricity is greater than or equal to the remaining power electricity of the toy car, a prompt message is sent to the smart terminal to avoid the trouble of lack of power electricity in the middle.

For the simulation intelligent electric toy car with intelligent path planning of present invention, the internet connection module is configured to establish a connection with other smart home device, and send an operation instruction to the other smart home device when the toy car is within a predetermined distance from the home door position, so that the other smart home device executes the operation instruction.

For example, in the case where the child needs to take the medicine immediately, the toy car can send an operation instruction to the intelligent heating device before the home is approached, so that the device automatically completes the heating of the medicine, and the child can take it at home to facilitate life.

### Example 2

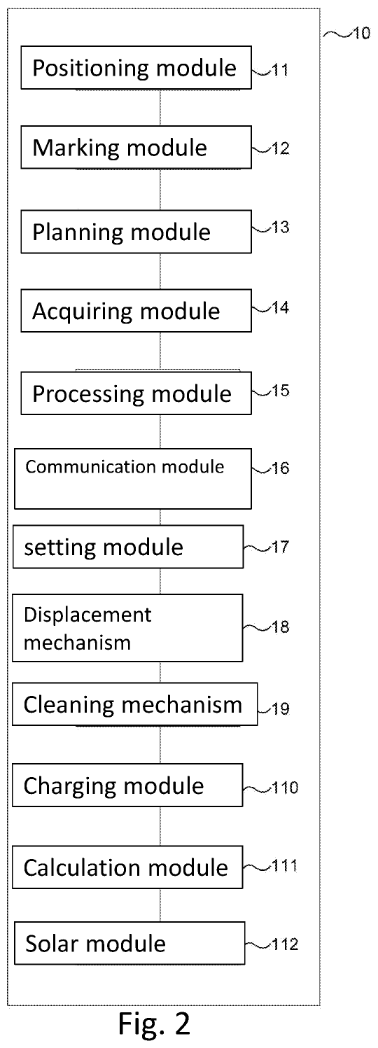

FIG. 2 shows a simulation intelligent electric toy car with intelligent path planning. As shown in FIG. 2, the simulation intelligent electric toy car 10 includes a positioning module 11, a marking module 12, a planning module 13, an acquiring module 14, a processing module 15, a communication module 16, a setting module 17, a displacement mechanism 18, a cleaning mechanism 19, a charging module 110 and a calculation module 111.

The positioning module 11 is configured to mark elevator position coordinates and home door position coordinates in the same coordinate system, and drive the toy car 10 to automatically travel from the home door to the elevator and travel from the elevator to the home door according to the elevator position coordinates and the home door position coordinates. The toy car can automatically be driven inside the elevator for easy use. Parents do not need to carry the toy car into the elevator by manpower.

The marking module 12 is configured to mark coordinates of a specific location according to an indication of the user. The planning module is configured to plan a specific path according to coordinates of the specific location, and drive the toy car to automatically travel along the specific path. It can make the toy car automatically travel along the preset road routing, which is easy to operate and easy for parents to take care of children.

Parents can plan specific routes along specific locations such as pavilions in the park, so that the toy car can automatically travel along the specific path, greatly reducing the human resources required for parents to supervise the toy car, providing parents with extreme great convenience.

The acquiring module 14 is configured to acquire, by using a camera, an object that which the toy car passes through car during driving. The processing module 15 is configured to analyze the object to obtain a name and related content of the object, and convert the related content into an audio format for playing. It can make the toy car be able to play the name and related content of the object in the street to children, which can enable children intuitively and specifically acquire knowledge and entertain.

When the child uses the toy car, the toy car can automatically broadcast information related to the scenery along the way. For example, when the toy car passes through the flower bed, the toy car can automatically recognize the name of the flower in the flower bed and play it out so that the child can get an intuitive understanding.

The communication module 16 is configured to communicate with a smart terminal of the user. The communication module is configured to implement a video call with a driver of the toy car through a camera disposed in the toy car and a camera of the smart terminal, which allows parents to follow the toy car without going close, or to talk to children.

The communication module 16 is configured to send location information of the smart terminal to the toy car. The setting module 17 is configured to preset a relative position, wherein the toy car moves together with the smart terminal, and maintains the relative position with the smart terminal, which enables the toy cars to follow the parent's movement and maintain a preset relative position with the parents.

In order to facilitate the parents to take care of the children, the position of the toy car should be located in front of the parents. For example, the relative position of the toy car can be preset to be 2 meters ahead of the smart terminal, so that the toy car can automatically follow the parent movement without manual operation, and keep 2 meters in front of the parents so parents can take care of the children.

The displacement mechanism 18 is configured to drive the toy car to be vertically or horizontally displaced by a predetermined amplitude, which makes the toy cars play the role of “rocking car” or cradle for comforting children.

The displacement mechanism 18 drives the vertical or horizontal displacement of the toy car so that the toy car can provide a variety of entertainment modes like the action of a “rocking car” or the action of a cradle.

As for the cleaning mechanism, a chassis of the toy car is provided with an engaging opening, configured to engage with a rag. The displacement mechanism 19 is configured to drive the cleaning mechanism to be displaced such that the cleaning mechanism fits the ground. When the toy car encounters an obstacle during driving, it automatically turns to 90 degrees so that the toy car can be used to clean the ground.

The charging module 110 is configured to detect power of the toy car, and drive the toy car to a preset charging port for charging according the position coordinate of the preset charging port when the power of the toy car is lower than a preset value, which enables the toy cars to automatically charge.

The calculation module 111 is configured to plan a travel route according to a destination set by the user, calculate a required power according to the travel route, detect a remaining power of the toy car, and send a reminder message to the smart terminal if the required power is greater than or equal to the remaining power of the toy car.

When the user sets the destination to “Blue Sky Kindergarten”, the calculation module 111 can query the kindergarten address through the network, and plan a driving route according to the address. If various driving routes are available for the user to select, the required power electricity is calculated according to the driving route. The required power electricity should be reasonably reserved for a certain margin. The round-trip power electricity is calculated. The remaining power electricity of the toy car is detected. When the required power electricity is greater than or equal to the remaining power electricity of the toy car, a prompt message is sent to the smart terminal to avoid the trouble of lack of power electricity in the middle.

For the simulation intelligent electric toy car with intelligent path planning of present invention, the internet connection module is configured to establish a connection with other smart home device, and send an operation instruction to the other smart home device when the toy car is within a predetermined distance from the home door position, so that the other smart home device executes the operation instruction.

For example, in the case where the child needs to take the medicine immediately, the toy car can send an operation instruction to the intelligent heating device before the home is approached, so that the device automatically completes the heating of the medicine, and the child can take it at home to facilitate life.

As the solar module, a housing of the toy car is made of a material capable of collecting solar energy. The collected solar energy is converted into electrical energy to supply electrical power to the toy car.

The communication module communicates with the smart terminal of the user through WIFI.

The foregoing description of the specific exemplary embodiments of the present invention is used to describe the invention. The description is not intended to limit the invention to the precise forms disclosed. The embodiments were chosen and described in order to explain the specific embodiments of the invention. Many changes and variation can be made. The scope of the invention is intended to be defined by the claims and their equivalents.

The embodiments of the device described above are merely illustrative, wherein the units described as separate components may or may not be physically separate, and the components displayed as units may or may not be physical units. In other words, it may be located at a place, or it can be distributed to multiple network units. Some or all of the modules may be selected according to actual needs to achieve the purpose of the solution of the embodiment. Those of ordinary skill in the art can understand and implement without creative labor.

What is claimed is:

1. A simulation intelligent electric toy car with intelligent path planning, comprising:
a positioning module, configured to mark elevator position coordinates and home door position coordinates in the same coordinate system, and drive the toy car to automatically travel from the home door to the elevator and travel from the elevator to the home door according to the elevator position coordinates and the home door position coordinates;
a marking module, configured to mark coordinates of a specific location according to an indication of the user;
a planning module, configured to plan a specific path according to coordinates of the specific location, and drive the toy car to automatically travel along the specific path;
an acquiring module, configured to acquire, by using a camera, an object that which the toy car passes through car during driving;
a processing module, configured to analyze the object to obtain a name and related content of the object, and convert the related content into an audio format for playing;
a communication module, configured to communicate with a smart terminal of the user;
wherein the communication module is configured to implement a video call with a driver of the toy car through a camera disposed in the toy car and a camera of the smart terminal;
wherein the communication module is configured to send location information of the smart terminal to the toy car;
a setting module, configured to preset a relative position, wherein the toy car moves together with the smart terminal, and maintains the relative position with the smart terminal;
a displacement mechanism, configured to drive the toy car to be vertically or horizontally displaced by a predetermined amplitude;
a cleaning mechanism, wherein a chassis of the toy car is provided with an engaging opening, configured to engage with a rag, and further wherein the displacement mechanism is configured to drive the cleaning mechanism to be displaced such that the cleaning mechanism fits the ground, and further wherein when the toy car encounters an obstacle during driving, it automatically turns to 90 degrees;
a charging module, configured to detect power of the toy car, and drive the toy car to a preset charging port for charging according the position coordinate of the preset charging port when the power of the toy car is lower than a preset value;
a calculation module, configured to plan a travel route according to a destination set by the user, calculate a required power according to the travel route, detect a remaining power of the toy car, and send a reminder message to the smart terminal if the required power is greater than or equal to the remaining power of the toy car;
an internet connection module, configured to establish a connection with other smart home device, and send an operation instruction to the other smart home device when the toy car is within a predetermined distance from the home door position, so that the other smart home device executes the operation instruction.

2. The simulation intelligent electric toy car with intelligent path planning of claim 1 further comprising a solar module, wherein a housing of the toy car is made of a material capable of collecting solar energy; the collected solar energy is converted into electrical energy to supply electrical power to the toy car.

3. The simulation intelligent electric toy car with intelligent path planning of claim 1, wherein the communication module communicates with the smart terminal of the user through WIFI.
